(19) United States
(12) Patent Application Publication
(10) Pub. No.: US 2026/0134618 A1
(43) Pub. Date: May 14, 2026

(54) CARGO MEASURING METHOD AND DEVICE

(71) Applicants: HYUNDAI MOTOR COMPANY, Seoul (KR); Kia Corporation, Seoul (KR)

(72) Inventors: Se Do OH, Hwaseong-si (KR); Jiuhn SONG, Hwaseong-si (KR); You Jin SHIN, Hwaseong-si (KR); Minkooc WEE, Hwaseong-si (KR)

(21) Appl. No.: 19/194,790

(22) Filed: Apr. 30, 2025

(30) Foreign Application Priority Data
Nov. 11, 2024 (KR) 10-2024-0159183

(51) Int. Cl. G06T 17/00; G06T 7/55

(52) U.S. Cl. CPC G06T 17/00; G06T 7/55

(57) ABSTRACT

A cargo measuring method, performed by a computing device including one or more processors and one or more memories, can include: connecting to a multi-sensor-based cargo measurer comprising a plurality of 3D depth sensors, obtaining a plurality of raw point clouds associated with a cargo measured by the multi-sensor-based cargo measurer, matching the plurality of raw point clouds into a single space to thereby create a single aligned point cloud, performing preprocessing on the aligned point cloud to thereby create a refined point cloud, inputting the refined point cloud into a deep learning model and reconstructing a final model by causing the deep learning model to predict a 3D mesh, and performing measurement of the cargo based on the final model.

### CROSS-REFERENCE TO RELATED APPLICATION

This application claims priority to and the benefit of Korean Patent Application No. 10-2024-0159183 filed at the Korean Intellectual Property Office on Nov. 11, 2024, the entire contents of which are incorporated herein by reference.

### TECHNICAL FIELD

The disclosure relates to a cargo measuring method and a device, and more specifically, to a cargo measuring method and a device capable of accurately and quickly measuring large cargo.

### BACKGROUND

In the modern logistics and air transportation industries, accurately measuring weight, volume, length, height, and shape of large cargo delivered to cargo terminals is essential. This information plays a critical role in calculating transportation costs and determining both the loading sequence and stowage location within an aircraft. However, accurately measuring the volume of large or irregular cargo presents several challenges.

Currently, workers rely on internal guidelines to stack, group, and package box-type loads. For standard cargo, volume is often measured manually using a tape measure. However, such manual methods are prone to variations based on the worker's skill and become even more unreliable when applied to irregularly shaped items. These inconsistencies frequently result in errors when calculating freight rates, particularly for irregular cargo, where accurate volume measurement determination is significantly more difficult.

Existing measurement equipment typically estimates volume by treating the outermost boundaries of large cargo as a rectangular parallelepiped. While this may suffice for regular items, it results in substantial measurement errors for irregularly shaped or skid-type cargo, often leading to inflated volume estimates and corresponding overcharges.

In addition, because cargo is manually packaged according to internal procedures, there are often inconsistencies in the time required and in the packaging outcomes. These inconsistencies frequently necessitate repackaging during the aircraft loading process, thereby reducing overall operational efficiency. The problem is compounded by structural characteristics of aircraft cargo spaces, particularly their irregular geometry and rounded roofs, make it difficult to determine an optimal loading order. This can result in inefficient stowage, increased empty space, and unnecessary cost losses.

### SUMMARY

The present disclosure is directed to a cargo measuring method and device capable of performing accurate and quick measurement of large cargo.

According to one aspect of the subject matter described in this application, a cargo measuring method can be performed by a computing device comprising one or more processors and one or more memories. The cargo measuring method can include connecting to a multi-sensor-based cargo measurer comprising a plurality of 3D depth sensors, obtaining a plurality of raw point clouds associated with a cargo measured by the multi-sensor-based cargo measurer, matching the plurality of raw point clouds into a single space to thereby create a single aligned point cloud, performing preprocessing on the aligned point cloud to thereby create a refined point cloud, inputting the refined point cloud into a deep learning model and reconstructing a final model by causing the deep learning model to predict a 3D mesh, and performing measurement on the cargo based on the final model.

Implementations according to this aspect can include one or more of the following features. For example, performing the preprocessing can include applying a plurality of point cloud samplings to the aligned point cloud.

In some examples, the plurality of point cloud samplings can include random sampling, voxel sampling, and uniform sampling. In some implementations, performing the preprocessing can include dividing the cargo and a bottom surface supporting the cargo from the aligned point cloud, separating a boundary between the cargo and the bottom surface for a lower portion of the cargo, and removing the bottom surface from the aligned point cloud.

In some examples, separating the boundary can include setting a threshold value based on a distance between the cargo and the bottom surface; and identifying a point corresponding to the bottom surface based on the threshold value. In some implementations, dividing the cargo and the bottom surface can include extracting the bottom surface based on a random sample consensus (RANSAC) algorithm, and dividing the cargo based on the extracted bottom surface.

In some implementations, reconstructing the final model can include constructing a K-dimensional tree (KD-tree) space based on a mesh vertex of the 3D mesh, placing a colored point cloud in the KD-tree space, and calculating adjacent points and a distance between the adjacent points. In some examples, reconstructing the final model can include performing color matching by collecting a color of a point adjacent to the mesh vertex, and reconstructing a colored mesh into the final model.

In some examples, reconstructing the final model can include creating a heatmap mesh based on the distance of adjacent points, and reconstructing the heatmap mesh into the final model. In some implementations, performing measurement on the cargo can include calculating a water volume of the cargo.

According to another aspect of the subject matter described in this application, a cargo measuring device can include one or more processors and one or more memories into which one or more instructions are loaded. The one or more instructions can be executed by the one or more processors, causing the one or more processors to perform operations comprising connecting to a multi-sensor-based cargo measurer comprising a plurality of 3D depth sensors, obtaining a plurality of raw point clouds associated with a cargo measured by the multi-sensor-based cargo measurer, matching the plurality of raw point clouds into a single space to thereby create a single aligned point cloud, performing preprocessing on the aligned point cloud to thereby create a refined point cloud, inputting the refined point cloud into a deep learning model and reconstructing a final model by causing the deep learning model to predict a 3D mesh, and performing measurement of the cargo based on the final model.

Implementations according to this aspect may include one or more of the following features. For example, performing the preprocessing comprises applying a plurality of point cloud samplings to the aligned point cloud.

In some examples, the plurality of point cloud samplings can include random sampling, voxel sampling, and uniform sampling. In some implementations, performing the preprocessing can include dividing the cargo and a bottom surface supporting the cargo from the aligned point cloud, separating a boundary between the cargo and the bottom surface for a lower portion of the cargo, and removing the bottom surface from the aligned point cloud.

In some examples, separating the boundary can include setting a threshold value based on a distance between the cargo and the bottom surface, and identifying a point corresponding to the bottom surface based on the threshold value. In some examples, dividing the cargo and the bottom surface can include extracting the bottom surface based on a random sample consensus (RANSAC) algorithm, and dividing the cargo based on the extracted bottom surface.

In some implementations, reconstructing the final model can include constructing a K-dimensional tree (KD-tree) space based on a mesh vertex of the 3D mesh, placing a colored point cloud in the KD-tree space, and calculating adjacent points and a distance between the adjacent points. In some examples, reconstructing the final model can include performing color matching by collecting a color of a point adjacent to the mesh vertex, and reconstructing a colored mesh into the final model. In some examples, reconstructing the final model can include creating a heatmap mesh based on the distance of adjacent points, and reconstructing the heatmap mesh into the final model.

According to another aspect of the subject matter described in this application, a computer-readable recording medium, on which program code is recorded to a computing device comprising one or more processors and one or more memories, can execute connecting to a multi-sensor-based cargo measurer comprising a plurality of 3D depth sensors, obtaining a plurality of raw point clouds associated with a cargo measured by the multi-sensor-based cargo measurer, matching the plurality of raw point clouds into a single space to thereby create a single aligned point cloud, performing preprocessing on the aligned point cloud to thereby create a refined point cloud, inputting the refined point cloud into a deep learning model and reconstructing a final model by causing the deep learning model to predict a 3D mesh, and performing measurement of the cargo based on the final model.

### BRIEF DESCRIPTION OF THE DRAWINGS

FIG. 1 is a diagram illustrating an example of a cargo measuring device.

FIG. 2 is a diagram illustrating an example of a cargo measuring method.

FIGS. 3A and 3B are diagrams illustrating an example of the cargo measuring method.

FIG. 4 is a diagram illustrating an example of a computing device.

### DETAILED DESCRIPTION

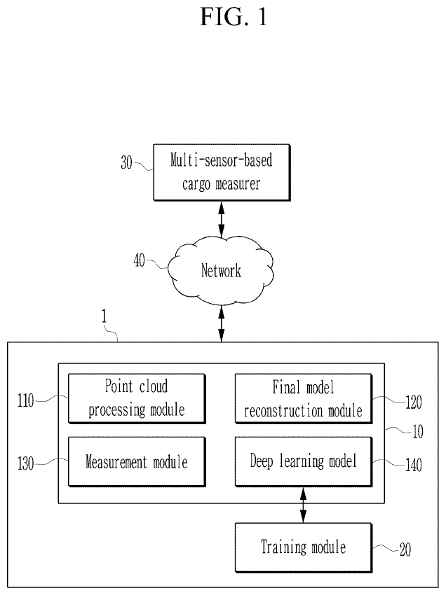

FIG. 1 is a diagram illustrating an example of a cargo measuring device (system) 1.

Referring to FIG. 1, a cargo measuring system 1 can include a cargo measuring device 10, a training module 20, and a multi-sensor-based cargo measurer 30. The cargo measuring device 10 and the multi-sensor-based cargo measurer 30 can exchange data through a network 40, and the training module 20 can train a deep learning model 140 used in the cargo measuring device 10 by using pre-prepared training data.

In FIG. 1, the training module 20 is shown as a component implemented at an outside of the cargo measuring device 10, but depending on the specific implementation purpose or environment, the training module 20 can be implemented within the cargo measuring device 10 or can be implemented on a remote server. When the training module 20 is implemented on a remote server, the cargo measuring device 10 can receive the trained deep learning model 140 from the remote server via the network 40.

The multi-sensor-based cargo measurer 30 can include a plurality of 3D depth sensors. The plurality of 3D depth sensors, each capturing raw point clouds of the cargo from different angles, can obtain a point cloud of the cargo. A plurality of raw point clouds can be obtained through the plurality of 3D depth sensors.

In some implementations, the multi-sensor-based cargo measurer 30 can further include a plurality of vision cameras. The plurality of vision cameras can obtain images of the cargo, each of the plurality of vision cameras capturing an image of the cargo from different angles. A plurality of raw images can be obtained through the plurality of vision cameras. The multi-sensor-based cargo measurer 30 can provide the plurality of obtained raw point clouds and raw images to the cargo measuring device 10 through the network 40.

In some implementations, the number of 3D depth sensors and the number of vision cameras used in the multi-sensor-based cargo measurer 30 can vary. For example, the number of vision cameras can exceed the number of 3D depth sensors. By way of further example, the multi-sensor-based cargo measurer 30 can utilize six vision cameras and four 3D depth sensors.

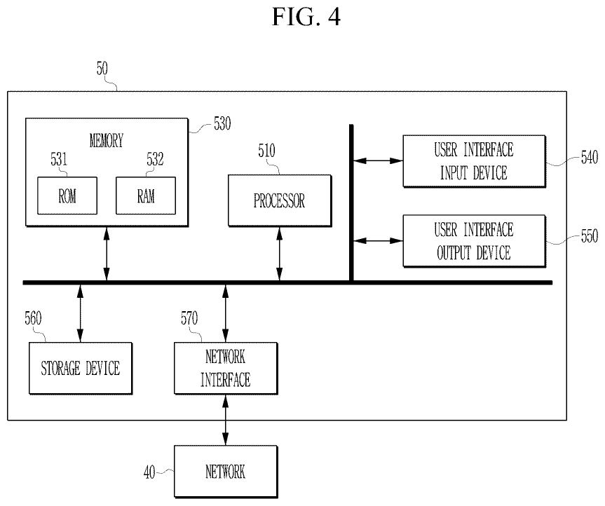

The cargo measuring device 10 can execute program codes or instructions loaded into one or more memory devices through one or more processors. For example, the cargo measuring device 10 can be implemented with a computing device 50 described below with reference to FIG. 4. In some implementations, one or more processors can correspond to a processor 510 of the computing device 50, and one or more memory devices can correspond to a memory 530 of the computing device 50. Program code or instructions can be executed by one or more processors to perform cargo measurement.

The cargo measuring device 10 can include a point cloud processing module 110, a final model reconstruction module 120, a measurement module 130, and the deep learning model 140.

The point cloud processing module 110 can be connected to the multi-sensor-based cargo measurer 30 and obtain the plurality of raw point clouds corresponding to the cargo measured by the multi-sensor-based cargo measurer 30. For example, if the multi-sensor-based cargo measurer 30 uses four 3D depth sensors, the point cloud processing module 110 can obtain four raw point clouds corresponding to each of the four depth sensors.

The point cloud processing module 110 can create a single aligned point cloud by matching the raw point cloud to a single space. This process, known as point cloud registration, can involve aligning the plurality of raw point clouds to a common coordinate system to create a single, consistent data set.

In some implementations, the point cloud processing module 110 can precisely align point clouds by first performing rough alignment by extracting feature points from the raw point clouds and finding corresponding points, and then repeatedly matching the nearest neighbors between points in each point cloud and minimizing the distance between the matched points. In addition, a transformation matrix including rotation, translation, and scaling can be applied to each point cloud. When the plurality of raw point clouds are merged into a single common coordinate system, they share the same reference frame, and the relative positions and directions of each cloud can be adjusted in the process.

The point cloud processing module 110 can perform preprocessing on the aligned point cloud to create a refined point cloud.

In some implementations, the point cloud processing module 110 can apply the plurality of point cloud samplings to the aligned point cloud. For example, the point cloud sampling can refer to selecting one or more points from a point cloud to adjust the density of data or improve processing efficiency. The point cloud processing module 110 can use two or more point cloud sampling techniques rather than just one point cloud sampling technique.

In some implementations, the point cloud sampling can include random sampling, voxel sampling, and uniform sampling. For example, the point cloud processing module 110 can perform point cloud sampling using random sampling and voxel sampling, and the user can appropriately adjust the usage proportion of each of random sampling and voxel sampling through predetermined parameters. By adopting the above-described method, more points can be selected in areas where more points are collected, and fewer points can be selected in areas where fewer points are collected.

In some implementations, the point cloud processing module 110 can separate the cargo from the bottom surface supporting the cargo within the aligned point cloud, and precisely separate the boundary between the cargo and the bottom surface, especially for the lower portion of the cargo that is not easily distinguishable from the bottom surface. Subsequently, the point cloud processing module 110 can remove the bottom surface from the aligned point cloud, leaving only the cargo.

In general, point cloud data includes both cargo and the bottom surface, so a process of distinguishing the two elements may be required. In particular, when the lower portion of the cargo is close to the bottom surface and the boundary is unclear, the point cloud processing module 110 may precisely distinguish the boundary between the cargo and the bottom surface to accurately identify the shape and location of the cargo. The point cloud processing module 110 effectively detects the bottom surface by applying an algorithm that distinguishes between cargo and the bottom surface, and performs the task of removing the bottom surface portion from the aligned point cloud, thereby leaving only the cargo. The above-described process includes refining the data for volumetric measurement or shape analysis of the cargo, ultimately enabling accurate measurement and analysis. Such bottom surface removal operations may be an important feature that reduces the complexity of point cloud data, allowing subsequent processing to focus solely on the cargo.

In some implementations, the point cloud processing module 110 can perform precise separation by setting a threshold value based on the distance between the cargo and the bottom surface and additionally identifying points corresponding to the bottom surface based on the threshold value. For example, the point cloud processing module 110 can analyze the location of each point, determine that a point within a threshold value range belongs to the bottom surface, and classify the point as the bottom surface. Through such methods, points belonging to the bottom surface can be accurately identified even in the lower areas of the cargo where the boundary with the bottom surface is ambiguous, enabling precise separation between the cargo and the bottom surface.

In some implementations, the point cloud processing module 110 can extract the bottom surface by a random sample consensus (RANSAC) algorithm to separate the bottom surface and separate the cargo based on the bottom surface. By adopting the RANSAC algorithm, a random point can be selected from the point cloud to create a planar model corresponding to the bottom surface, points that fit well to the planar model are identified as inliers, only the points that configure the bottom surface are extracted, and the other points are classified as outliers and separated into cargo.

The final model reconstruction module 120 can reconstruct the final model by inputting the refined point cloud into the deep learning model 140 and having the deep learning model 140 to predict a 3D mesh. For example, the final model reconstruction module 120 can construct the K-dimensional tree (KD-tree) space based on the mesh vertex of the three-dimensional mesh. Mesh vertices can have coordinates in three-dimensional space and can be important elements that define the overall shape and structure of the mesh. The KD-tree can be a data structure for efficiently managing and searching the mesh vertex, and each mesh vertex can be divided according to specific rules and stored in a tree form.

In some implementations, the final model reconstruction module 120 can place a colored point cloud in the KD-tree space. The colored point cloud can have RGB color information for each point and provide data for coloring the 3D mesh. Each point in the color point cloud can be mapped to the mesh vertex in the KD-tree, allowing colors corresponding to each area of the mesh to be assigned.

In some implementations, the final model reconstruction module 120 can calculate adjacent points and distances between adjacent points. Adjacent points can be efficiently searched using the structure of the KD-tree, and the color and uncertainty of the mesh vertex can be estimated based on the calculated distance information. The above-described process can increase the visual consistency of the mesh and create a final 3D model with color information.

In some implementations, the final model reconstruction module 120 can perform color matching by collecting colors of mesh vertices and adjacent points, and reconstruct the colored mesh into the final model.

In some implementations, the final model reconstruction module 120 can create a heatmap mesh based on the distances between adjacent points and reconstruct the heatmap mesh into the final model.

The measurement module 130 can perform measurement on the cargo using the final model. For example, the measurement module 130 can calculate water volume for the cargo. Water volume can refer to a process of measuring the total volume occupied by the cargo. This measurement can be understood as the volume of water the cargo would displace if it were submerged in a tank. The measurement module 130 can calculate the water volume by mathematically integrating the internal space of the cargo using a three-dimensional mesh model or by estimating the volume based on the outline and surface of the cargo. This function enables accurate volume measurement even when the size or shape of the cargo is irregular, and can provide useful data for calculating cargo transportation costs or establishing loading plans.

In some implementations, the accuracy of cargo measurement can be improved by obtaining a point cloud for cargo from a multi-sensor-based cargo measurer and performing preprocessing on the point cloud. In addition or alternatively, by inputting the point cloud with preprocessing applied into a deep learning model to create the 3D mesh for the cargo and performing measurement on it, automated measurement for large cargo can be implemented and fast and accurate measurement can be performed for large cargo.

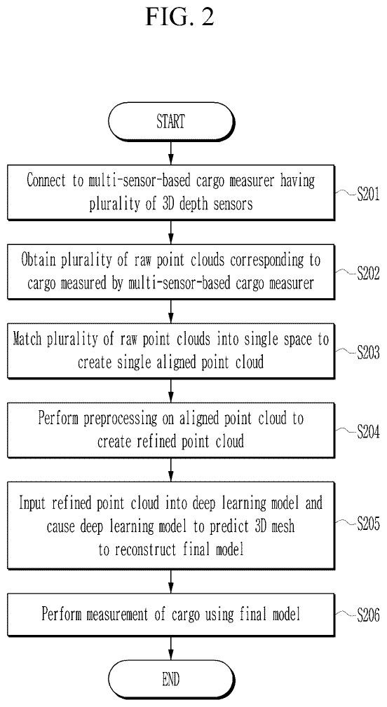

FIG. 2 is a diagram illustrating an example of a cargo measuring method.

Referring to FIG. 2, the cargo measuring method can include a step (S201) of connecting to the multi-sensor-based cargo measurer including the plurality of 3D depth sensors, a step (S202) of obtaining the plurality of raw point clouds corresponding to the cargo measured by the multi-sensor-based cargo measurer, a step (S203) of matching the plurality of raw point clouds into a single space to thereby create a single aligned point cloud, a step (S204) of performing preprocessing on the aligned point cloud to create the refined point cloud, a step (S205) of inputting the refined point cloud into the deep learning model and causing the deep learning model to predict the 3D mesh to reconstruct the final model, and a step (S206) of performing measurement on the cargo based on the final model.

For more detailed information about the above method, reference can be made to the description of the implementations described in this specification, so a redundant description is omitted here.

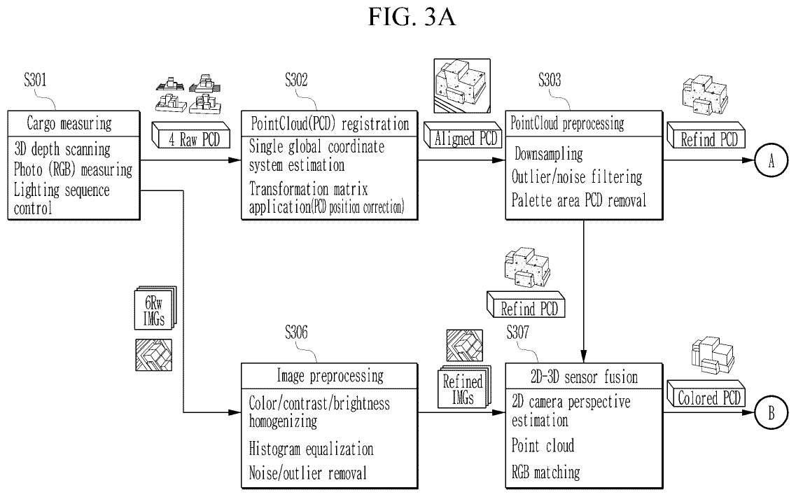

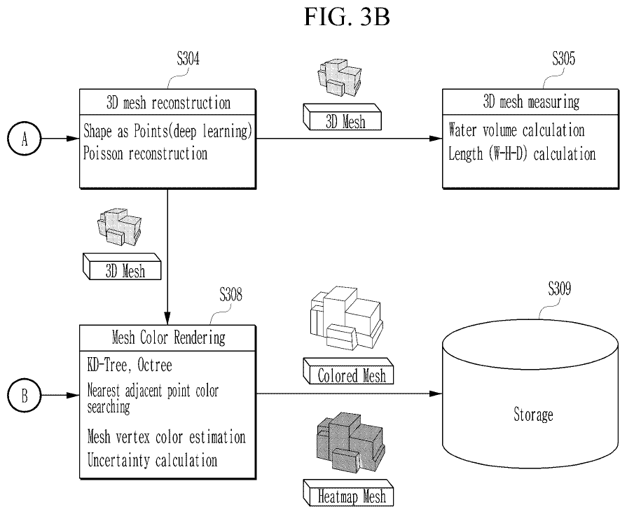

FIGS. 3A and 3B are diagrams illustrating an example of a cargo measuring method.

Referring to FIGS. 3A and 3B, the cargo measuring method can perform a step (S301) of measuring cargo. In this step, 3D depth scanning and RGB photography can performed to measure the 3D shape of the cargo. Lighting sequence can be controlled to optimize the measurement environment and collect high-quality data. Four raw point clouds and six raw images can be output as results.

A step (S302) can be a point cloud registration step. This step can be performed by receiving the output of the step (S301) of measuring cargo as input. The four raw point clouds can be aligned to a single global coordinate system and the positions of each point cloud can be corrected by applying a transformation matrix. Finally, an aligned point cloud can be created.

A step (S303) can be a point cloud preprocessing step. This step can use the results of the step (S302) of point cloud registration as input. Downsampling can be used to reduce the size of data and improve data quality by filtering out outliers and noise. In addition or alternatively, the point cloud in the palette area can be removed to output a refined point cloud.

A step (S304) can include reconstructing the 3D mesh (see FIG. 3B). In this step, the refined point cloud from the step (S303) of point cloud preprocessing can be received as input and the 3D mesh can be created. Precise 3D meshes can be constructed using deep learning-based “shape as points” and Poisson reconstruction techniques. As a result, the 3D mesh can be output.

A step (S305) can include measuring the 3D mesh. In this step, measurement work can be performed using the 3D mesh created in the step (S304) of reconstructing the 3D mesh. By calculating the water volume and measuring the height, width, and depth (W-H-D) of the mesh, the volume and shape of the cargo can be accurately analyzed.

A step (S306) can include preprocessing an image (see FIG. 3A). This step can use the six raw images collected in the step (S301) of measuring cargo as input. Image quality can be improved by homogenizing color, contrast, and brightness, and by performing histogram equalization and noise removal. As a result, a refined image can be created.

A step (S307) can include fusing 2D-3D sensor. This step can be performed using the output of the step (S303) of preprocessing point cloud and the step (S306) of preprocessing the image. Perspective estimation of a 2D camera can be performed, and a color point cloud can be created by matching the point cloud with an RGB image.

A step (S308) can include rendering mesh color. In this step, the 3D mesh created in the step (S304) of reconstructing the 3D mesh and the color point cloud created in the step (S307) of fusing 2D-3D sensor can be used as input. This process uses KD-trees and octrees to search the color of the nearest adjacent point of each vertex in the mesh, which can be used to estimate the color of the mesh vertices. In addition, the uncertainty for color estimation can be calculated to estimate the reliability of the mesh. As a result, the color mesh and the heatmap mesh can be created, which can enhance the 3D visualization of the cargo.

A step (S309) can include saving the created mesh. In the final step, the color mesh and the heatmap mesh created in the step (S308) of rendering mesh color can be saved. The color mesh and the heatmap mesh can be stored in a database or file system for later analysis or reference.

In accordance with this, the accuracy of measuring cargo can be improved by obtaining a point cloud of the cargo from the multi-sensor-based cargo measuring device and performing preprocessing on the point cloud. In addition, by inputting the point cloud with preprocessing applied into a deep learning model to create the 3D mesh for the cargo and performing measurement on it, automated measurement can be implemented for large cargo and fast and accurate measurement cab be performed for large cargo.

FIG. 4 is a diagram illustrating an example of a computing device.

Referring to FIG. 4, the method and device for measuring cargo can be implemented using the computing device 50. The computing device 50 can be implemented as various types of electronic devices, servers or similar devices, and its function can be implemented through a combination of software and hardware.

The computing device 50 can include at least one of the processor 510, a memory 530, a user interface input device 540, a user interface output device 550, or a storage device 560 communicating through a bus 520. The computing device 50 can also include a network interface 570 electrically connected to a network 40. The network interface 570 can transmit or receive signals to or from other entities through the network 40.

The processor 510 can be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 can also be a semiconductor device that executes instructions stored in the memory 530 or the storage device 560 and can play a key role in the system. Program codes and data stored in the memory 530 or the storage device 560 can instruct the processor 510 to perform specific tasks, thereby enabling the overall operation of the system. The processor 510 can be configured to implement various functions and methods described above with respect to FIGS. 1 to 3B.

The memory 530 and storage device 560 can include various forms of volatile or non-volatile storage medium for storing and accessing data of the system. For example, the memory 530 can include a read-only memory (ROM) 531 and a random-access memory (RAM) 532. In some implementations, the memory 530 can be built into the processor 510, in which case data transmission speeds between the memory 530 and the processor 510 may be very fast. In some implementations, the memory 530 can be disposed external to the processor 510, in which case the memory 530 can be connected to the processor 510 through various data buses or interfaces. This connection can be made through a variety of known means—for example, a peripheral component interconnect express (PCIe) interface for high-speed data transmission or a memory controller.

In some implementations, at least some of the components or functions of the method and device for measuring cargo can be implemented as a program or software executed on the computing device 50, and the program or software can be stored on a computer-readable recording medium or storage medium. For example, a computer-readable recording medium or storage medium can record a program for executing steps included in an implementation of the method and device for measuring cargo, on a computer including the processor 510 executing a program or instructions stored in the memory 530 or the storage device 560.

In some implementations, at least some of the components or functions of the method and device for measuring cargo can be implemented using hardware or circuitry of the computing device 50, or can be implemented as separate hardware or circuitry that may be electrically connected to the computing device 50.

In some implementations, the accuracy of cargo measurement can be improved by obtaining a point cloud for cargo from a multi-sensor-based cargo measurer and performing preprocessing on the point cloud. In addition, by inputting the preprocessed point cloud into a deep learning model to create a 3D mesh for the cargo and performing measurement on it, automated measurement can be implemented for large cargo and fast and accurate measurement can be performed for large cargo.

What is claimed is:

1. A cargo measuring method performed by a computing device comprising one or more processors and one or more memories, the method comprising:
connecting to a multi-sensor-based cargo measurer comprising a plurality of 3D depth sensors;
obtaining a plurality of raw point clouds associated with a cargo measured by the multi-sensor-based cargo measurer;
matching the plurality of raw point clouds into a single space to thereby create a single aligned point cloud;
performing preprocessing on the aligned point cloud to thereby create a refined point cloud;
inputting the refined point cloud into a deep learning model and reconstructing a final model by causing the deep learning model to predict a 3D mesh; and
performing measurement on the cargo based on the final model.

2. The cargo measuring method of claim 1, wherein performing the preprocessing comprises applying a plurality of point cloud samplings to the aligned point cloud.

3. The cargo measuring method of claim 2, wherein the plurality of point cloud samplings comprise random sampling, voxel sampling, and uniform sampling.

4. The cargo measuring method of claim 1, wherein performing the preprocessing comprises:
dividing the cargo and a bottom surface supporting the cargo from the aligned point cloud,
separating a boundary between the cargo and the bottom surface for a lower portion of the cargo, and
removing the bottom surface from the aligned point cloud.

5. The cargo measuring method of claim 4, wherein separating the boundary comprises:
setting a threshold value based on a distance between the cargo and the bottom surface; and
identifying a point corresponding to the bottom surface based on the threshold value.

6. The cargo measuring method of claim 4, wherein dividing the cargo and the bottom surface comprises:
extracting the bottom surface based on a random sample consensus (RANSAC) algorithm; and
dividing the cargo based on the extracted bottom surface.

7. The cargo measuring method of claim 1, wherein reconstructing the final model comprises:
constructing a K-dimensional tree (KD-tree) space based on a mesh vertex of the 3D mesh,
placing a colored point cloud in the KD-tree space, and
calculating adjacent points and a distance between the adjacent points.

8. The cargo measuring method of claim 7, wherein reconstructing the final model comprises:
performing color matching by collecting a color of a point adjacent to the mesh vertex, and
reconstructing a colored mesh into the final model.

9. The cargo measuring method of claim 7, wherein reconstructing the final model comprises:
creating a heatmap mesh based on the distance of adjacent points, and
reconstructing the heatmap mesh into the final model.

10. The cargo measuring method of claim 1, wherein performing measurement on the cargo comprises calculating a water volume of the cargo.

11. A cargo measuring device comprising:
one or more processors; and
one or more memories into which one or more instructions are loaded,
wherein the one or more instructions are executed by the one or more processors, causing the one or more processors to perform operations comprising:
connecting to a multi-sensor-based cargo measurer comprising a plurality of 3D depth sensors,
obtaining a plurality of raw point clouds associated with a cargo measured by the multi-sensor-based cargo measurer,
matching the plurality of raw point clouds into a single space to thereby create a single aligned point cloud,
performing preprocessing on the aligned point cloud to thereby create a refined point cloud,
inputting the refined point cloud into a deep learning model and reconstructing a final model by causing the deep learning model to predict a 3D mesh, and
performing measurement of the cargo based on the final model.

12. The cargo measuring device of claim 11, wherein performing the preprocessing comprises applying a plurality of point cloud samplings to the aligned point cloud.

13. The cargo measuring device of claim 12, wherein the plurality of point cloud samplings comprise random sampling, voxel sampling, and uniform sampling.

14. The cargo measuring device of claim 11, wherein performing the preprocessing comprises:
dividing the cargo and a bottom surface supporting the cargo from the aligned point cloud,
separating a boundary between the cargo and the bottom surface for a lower portion of the cargo, and
removing the bottom surface from the aligned point cloud.

15. The cargo measuring device of claim 14, wherein separating the boundary comprises:
setting a threshold value based on a distance between the cargo and the bottom surface, and
identifying a point corresponding to the bottom surface based on the threshold value.

16. The cargo measuring device of claim 14, wherein dividing the cargo and the bottom surface comprises:
extracting the bottom surface based on a random sample consensus (RANSAC) algorithm, and
dividing the cargo based on the extracted bottom surface.

17. The cargo measuring device of claim 11, wherein reconstructing the final model comprises:
constructing a K-dimensional tree (KD-tree) space based on a mesh vertex of the 3D mesh,
placing a colored point cloud in the KD-tree space, and
calculating adjacent points and a distance between the adjacent points.

18. The cargo measuring device of claim 17, wherein reconstructing the final model comprises:
performing color matching by collecting a color of a point adjacent to the mesh vertex, and
reconstructing a colored mesh into the final model.

19. The cargo measuring device of claim 17, wherein reconstructing the final model comprises:
creating a heatmap mesh based on the distance of adjacent points, and
reconstructing the heatmap mesh into the final model.

20. A computer-readable recording medium, on which program code is recorded to a computing device comprising one or more processors and one or more memories, to execute:
connecting to a multi-sensor-based cargo measurer comprising a plurality of 3D depth sensors;
obtaining a plurality of raw point clouds associated with a cargo measured by the multi-sensor-based cargo measurer;
matching the plurality of raw point clouds into a single space to thereby create a single aligned point cloud;
performing preprocessing on the aligned point cloud to thereby create a refined point cloud;
inputting the refined point cloud into a deep learning model and reconstructing a final model by causing the deep learning model to predict a 3D mesh; and
performing measurement of the cargo based on the final model.
